(19) United States
(12) Patent Application Publication
(10) Pub. No.: US 2020/0380506 A1
(43) Pub. Date: Dec. 3, 2020

(54) SYSTEMS AND METHODS FOR FINANCIAL AUTHENTICATION HOTSPOT

(71) Applicant: Wells Fargo Bank, N.A., San Francisco, CA (US)

(72) Inventors: Michael Chang, Millbrae, CA (US); John Chuprevich, Davidson, NC (US); Kevin R. Cieslak, Novato, CA (US); Christopher P. Clausen, Novato, CA (US); Jeffrey A. Cornman, San Francisco, CA (US); Bryan Hall, Charlotte, NC (US); Julio Jiron, San Bruno, CA (US); Bryan Kroll, San Mateo, CA (US); Samuel Martin, San Francisco, CA (US); Traci Nguyen, San Francisco, CA (US); Virginia Randle, Tega Cay, SC (US); Priyamvada Singh, San Francisco, CA (US); Darrell L. Suen, San Ramon, CA (US); Kenneth L. Wright, Charlotte, NC (US)

(21) Appl. No.: 15/385,187

(22) Filed: Dec. 20, 2016

(51) Int. Cl. G06Q 20/40; G06Q 20/10; H04W 12/06; G06F 17/30; H04W 76/02; G06Q 40/02; G06Q 20/32

(52) U.S. Cl. CPC G06Q 20/40; G06Q 20/1085; H04W 12/06; G06Q 20/3221; H04W 76/02; G06Q 40/02; G06Q 20/3226; G06F 17/30312

(57) ABSTRACT

Systems and methods using a processor coupled to a non-transitory storage medium. The processor is structured to receive an indication of a mobile device connected to a secure network provided by a financial institution, where the mobile device is associated with a user account at the financial institution, identify the mobile device based on a unique identifier of the mobile device, automatically authenticate the mobile device for a first level transaction, receive a transaction request from a user via the mobile device, determine that the transaction request is for the first level transaction, and complete the transaction request.

### TECHNICAL FIELD

Embodiments of the present disclosure relate generally to the field of authentication of financial transactions.

### BACKGROUND

Financial institutions desire a secure and efficient process for authenticating transactions for customers. Traditionally, the authentication process of performing financial transactions requires a customer to either perform the transaction in-person with a financial institution teller at a branch location or enter authentication information regarding the customer's identity and related account information to complete the transaction electronically. Accordingly, for each transaction, the customer may be required to enter the same information repetitively. When a customer is trying to make a quick transfer of funds or perform another quick task relating to the financial institution, the customer may desire to be automatically authenticated if certain conditions are met. In this regard, financial institutions may benefit from a system where automatic authentication is possible.

### SUMMARY

A first example embodiment relates to a system. The system includes a processor coupled to a non-transitory storage medium, wherein the processor is structured to receive an indication of a mobile device connected to a secure network provided by a financial institution, where the mobile device is associated with a user account at the financial institution, identify the mobile device based on a unique identifier of the mobile device, automatically authenticate the mobile device for a first level transaction, receive a transaction request from a user via the mobile device, determine that the transaction request is for the first level transaction, and complete the transaction request.

Another example embodiment relates to a system. The system includes a processor coupled to a non-transitory storage medium, wherein the processor is structured to receive an indication of a mobile device connected to a secure network provided by a financial institution, identify the mobile device based on a unique identifier of the mobile device, authenticate the mobile device for a first level transaction, receive a transaction request from a user via the mobile device, determine a level of authentication necessary to complete the transaction request, and prompt a second level of authentication, based at least in part on the level of authentication necessary to complete the transaction request. The processor is further structured to receive the second level of authentication from the user via the mobile device and complete the transaction request.

Another example embodiment relates to a method. The method includes receiving, by a financial institution computing system comprising at least one processor connected with at least one memory device, an indication of a mobile device connected to a secure network provided by a financial institution. The method further includes identifying a unique identifier associated with the mobile device and binding the mobile device via the unique identifier to a user account at the financial institution. The method further includes automatically authenticating the mobile device for a first level transaction, receiving a transaction request from the user via the mobile device, determining that the transaction request is for the first level transaction, and completing the first level transaction.

These and other features, together with the organization and manner of operation thereof, will become apparent from the following detailed description when taken in conjunction with the accompanying drawings.

### BRIEF DESCRIPTION OF THE DRAWINGS

FIG. 1 is a schematic diagram of an authentication system, according to an example embodiment.

FIG. 2 is a diagram of the authentication system of FIG. 1, according to an example embodiment.

FIG. 3 is a flow diagram of a method of authenticating a mobile device using the authentication system of FIGS. 1-2, according to an example embodiment.

FIG. 4 is a flow diagram of a method for automatically authenticating a mobile device using the authentication system of FIGS. 1-2, according to an example embodiment.

FIG. 5 is a diagram of an environment for implementing the method of FIG. 4, according to an example embodiment.

FIG. 6 is a diagram of a display generated by the authentication system of FIGS. 1-2 and the method of FIG. 3, according to an example embodiment.

### DETAILED DESCRIPTION

Referring to the Figures generally, various systems, methods, and apparatuses relate to an authentication system structured to authenticate a registered mobile device connected to a secure network provided by a financial institution to perform a transaction request. According to the present disclosure, the authentication system facilitates completion of transaction requests from a user's registered mobile device. The authentication system completes transactions via a lower level of authentication upon connection of the registered mobile device to a secure network provided by the financial institution. The secure network may be located at a branch of the financial institution, may be provided at partnered locations (e.g., coffee shop, gas station, department store), and additionally, may be provided at a base location (e.g., a user's home, a user's office). The authentication level required for completion of a transaction request is determined based on whether the mobile device connected to the secure network is registered with the financial institution and also, on the type of transaction requested via the mobile device. Each type of transaction that may be requested via the mobile device corresponds to a level of transaction requiring different levels of authentication. For example, a first level transaction may correspond to a relatively small transfer of funds (e.g., $1000 or less) and a second level transaction may correspond to a relatively larger transfer of funds (e.g., more than $1000), and so on. Furthermore, for authentication via the network, a first level transaction may only require that the mobile device has been connected to the secure network at least one time prior to the transaction request and registered with the network. During that prior connection to the secure network, the mobile device would have been registered as a recognized device by the financial institution using the unique identifier associated with the mobile device. The unique identifier is bound to an account at the financial institution such that transactions involving that account can be authenticated using a lower level of authentication upon connection of the mobile device to the secure network. As a further example, for authentication of the transaction via the mobile device connected to the network, a second level transaction may require that the mobile device has been registered with the secure network, bound to an account at the financial institution, and additionally, that the user enter a second level of authentication (e.g., username and login) while connected to the secure network. Other levels of transactions may require further authentication. In arrangements where the mobile device is not connected to a secure network, authentication can still occur, but without any automatic authentication of lower level transactions. Thus, without connection to the network, the user of the mobile device will be prompted to enter all levels of authentication instead of only the lower level of authentication (e.g., automatic first level authentication) as described above.

An example implementation may be described as follows. A user of a mobile device may enter a financial institution branch equipped with a secure network. When the user enters the financial institution branch, the mobile device connects to the secure network provided at that location. The authentication system identifies the mobile device connected to the network through an associated mobile device identifier bound to a user account at the financial institution. The authentication system automatically authenticates the mobile device for a first level transaction (e.g., a transaction requiring a low level of security) upon connection to the network. For example, the first level transaction may allow the user to transfer a small amount of funds to another account holder at the financial institution via the mobile device such that only a first level of authentication is needed (i.e., the user does not also need to provide a biometric, a username/password combination, etc.). The authentication system then completes the transaction. However, if the user's mobile device is not connected to the network, the user may have to enter full user credentials to perform the transaction. Accordingly, the authentication system allows the user to perform certain transactions with a lower level of authentication upon connection to the secure network when a registered mobile device associated with the user is connected to the secure network. Beneficially, the user may perform transactions on a quicker, more efficient basis via the described authentication system.

In operation, the authentication system facilitates transfers of funds (or various other transactions) between account holders at the financial institution by providing this type of lower level authentication based on information received by the system regarding the mobile device (e.g., mobile device identifier). A user only needs to be connected to the secure network to perform these types of transactions using the mobile device. As an example, the authentication system facilitates quick transfers of funds when the financial institution branch is closed. The user connects to a secure network at the financial institution branch, another partnered location (e.g., coffee shop, gas station, department store), or at home. Connected to the secure network, the user can transfer funds to another individual (or various other first level transactions) using a lower level of authentication. If the mobile device of the user is automatically connected to a secure network, the user can transfer funds without any additional authentication (e.g., entering a username and password, etc.).

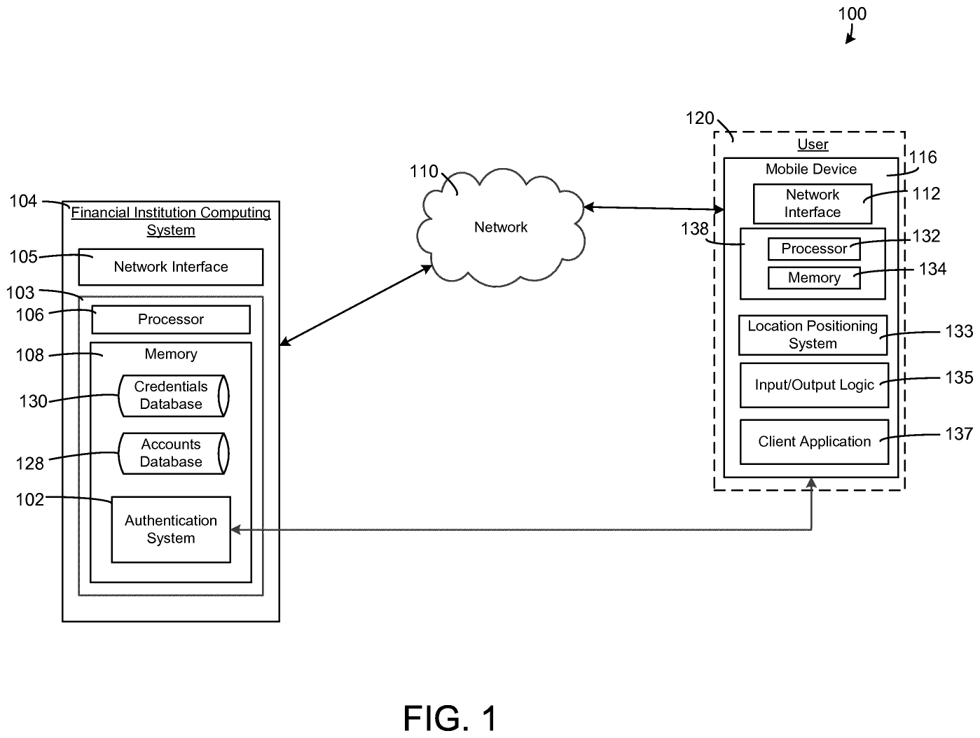

Referring now to FIG. 1, a diagram of a system 100 is shown according to an example embodiment. As described in further detail below, the system 100 facilitates authenticating a mobile device 116 upon connection to a secure network (e.g., network 110). The system 100 detects or receives an indication of the mobile device 116 when the mobile device 116 is connected to the network 110. The system identifies the connected mobile device through an associated mobile device identifier (e.g., media access control (MAC) address, serial number, token, etc.), which is bound to an account of the user 120. The system 100 also automatically authenticates the mobile device 116 for a first level transaction upon connection to the network 110. Upon receipt of a transaction request from a user 120 via the mobile device 116, the system 100 prompts the user 120 for a second level of authentication if necessary based on the type of transaction request. Additionally, the system 100 may generate and selectively provide a message to the mobile device 116 to display a second level of authentication prompt based on the transaction request by the user 120. As shown, the system 100 includes a financial institution computing system 104 communicably and operatively coupled to a mobile device 116 associated with a user 120 over a network 110. The network 110 provides communicable and operative coupling between the mobile device 116 and the financial institution computing system 104 and the other components disclosed and described herein to provide and facilitate the exchange of communications (e.g., data, instructions, values, commands, etc.). Accordingly, the network 110 may include any network including wired (e.g., Ethernet) and/or wireless networks (e.g., 802.11X, ZigBee, Bluetooth, Internet, etc.). In some embodiments, the network 110 may further include a proprietary banking network to provide secure or substantially secure communications.

In some arrangements, the network 110 also includes a non-banking network, such as a home wireless network, work wireless network, merchant wireless network, and so on, that has been registered as a secure network with the system 100. The network 110 can be registered as a secure network based on a service set identifier (SSID), an Internet Protocol (IP) address, a MAC address, a router serial number, and so on. The network 110 can be registered using any unique network identifier registered with the system 100, such that a user 120 can complete transactions via a mobile device 116 connected to the network 110 using lower level authentication. The network 110 is registered via the system 100 for use with the transactions occurring at the financial institution (e.g., transfers from and to user accounts, bill pay, etc.). For example, a user 120 may use a non-banking secure network at his or her home to complete lower level authenticated transactions, such as a transfer of $100 to another customer of the financial institution, via the mobile device 116 of the user 120.

The user 120 may be any person or entity using the mobile device 116. The user 120 may be any person or entity using the authentication system 102 to perform transactions with a lower level of required authentication. Such a user 120 may be a customer of the financial institution (e.g., an account holder at the financial institution). The user 120 may use the mobile device 116 to request services provided by the financial institution.

The mobile device 116 can include any type of mobile device that may be used by a user 120 in connection with services provided by a financial institution. The mobile device 116 may include any wearable device. Wearable devices refer to any type of device that a user 120 wears including, but not limited to, a watch (e.g., a smart watch), glasses (e.g., eye glasses, sun glasses, smart glasses, etc.), bracelet (e.g., a smart bracelet), etc. Mobile devices 116 may also include any type of mobile device of a user 120 including, but not limited to, a phone (e.g., a smartphone, etc.) and a computing device (e.g., a tablet computer, a laptop computer, a person digital assistant, etc.). Accordingly, the mobile device 116 may include a display device (e.g., a screen) and one or more input/output devices (e.g., a touch screen, microphone, speaker, keyboard, etc.).

The mobile device 116 includes a unique identifier (e.g., MAC address, serial number, token, etc.) that is bound to an account of the user 120 at the financial institution. Through the mobile device identifier, a connected mobile device 116 is identified by the system 100 using the mobile device identifier. Thus, identifying the mobile device 116 of the user 120 (e.g., via detection circuit 202 described below) upon connection to the secure network 110 allows the system 100 to identify the customer account with which the mobile device 116 is associated such that lower level authentication of transactions associated with that account can be completed by the system 100.

As shown, the mobile device 116 includes a processing circuit 138, which includes a processor 132, memory 134, location positioning system 133, input/output logic 135, client application 137, and network interface 112. The network interface 112 of the mobile device 116 is adapted for and configured to establish a communication session via the network 110 with the financial institution computing system 104 and authentication system 102. Accordingly, the network interface 112 includes any of a cellular transceiver (Code Division Multiple Access (CDMA), Global System for Mobile Communications (GSM), Long-Term Evolution (LTE), etc.), a wireless network transceiver (e.g., 802.11X, ZigBee, Bluetooth, etc.), or a combination thereof (e.g., both a cellular transceiver and a Bluetooth transceiver).

The processing circuit 138 includes a processor 132 and a memory 134. The processor 138 may be implemented as a general-purpose processor, an application specific integrated circuit (ASIC), one or more field programmable gate arrays (FPGAs), a digital signal processor (DSP), a group of processing components that may be distributed over various geographic locations or housed in a single location, or other suitable electronic processing components. The one or more memory devices 134 (e.g., RAM, NVRAM, ROM, Flash Memory, hard disk storage, etc.) store data and/or computer code for facilitating the various processes described herein. Moreover, the one or more memory devices 134 may be or include tangible, non-transient volatile memory or non-volatile memory. Accordingly, the one or more memory devices 134 include database components, object code components, script components, or any other type of information structure for supporting the various activities and information structures described herein.

The input/output logic 135 is structured to receive and provide communication(s) to a user 120 of the mobile device 116. In this regard, the input/output logic 135 is structured to exchange data, communications, instructions, etc. with an input/output component of the mobile device 116. Accordingly, in one embodiment, the input/output logic 135 includes an input/output device such as a display device, a touchscreen, a keyboard, and a microphone. In another embodiment, the input/output logic 135 includes communication circuitry for facilitating the exchange of data, values, messages, and the like between an input/output device and the components of the mobile device 116. In yet another embodiment, the input/output logic 135 includes machine-readable media for facilitating the exchange of information between the input/output device and the components of the mobile device 116. In still another embodiment, the input/output logic 135 includes any combination of hardware components (e.g., a touchscreen), communication circuitry, and machine-readable media.

The location positioning system 133 is structured to receive location data and determine a location or receive information indicative of a location of the mobile device 116. In one embodiment, the location positioning system 133 includes a global positioning system (GPS) or any other type of location positioning system. As such, the location positioning system 133 receives latitude data, longitude data, and any other type of location or position data to determine the location of the mobile device 116. In other embodiments, the location positioning system 133 receives location data from the financial institution computing system 104 that indicates the location of the mobile device 116. In still other embodiments, the location positioning system 133 receives an explicit location identification from the user 120 of the mobile device 116. All such variations are intended to fall within the spirit and scope of the present disclosure.

The client application 137 is communicably coupled to the financial institution computing system 104 (e.g., the accounts database 128) via the network 110 and is structured to permit management of the user's accounts via the client application 137. For example, the client application 137 may be a mobile banking application for a smartphone. In this regard, the client application 137 provides displays indicative of current account balances, pending transactions, profile information (e.g., contact information), and the like. Further, in some embodiments, the client application 137 also permits payments and/or transfers from the user 120 to a designated recipient. For example, the client application 137 may depict a loan of a user (e.g., mortgage) and allow the user to pay the mortgage from one of their accounts (e.g., checking or savings). In another example, a bill pay option may be provided by the client application 137, where the bill pay option allows the user 120 to pay his/her bills. In any of these examples, the client application 137 permits the user 120 to perform transactions using the authentication system 102 through the mobile device 116.

Still referring to FIG. 1, the system 100 also includes a financial institution computing system 104. The financial institution computing system 104 is associated with or operated by a financial institution (e.g., a bank, a credit card issuer, etc.) or any other entity interested in authenticating mobile devices 116 for financial institution services and/or transactions. In practice, the financial institution computing system 104 includes server computing systems, for example, comprising one or more networked computer servers having a processor and non-transitory machine readable media.

As such, the financial institution computing system 104 includes a network interface 105, which is used to establish connections with other components of the system 100 by way of network 110. The network interface 105 includes program logic that facilitates connection of the financial institution computing system 104 to the network 110. The network interface 105 supports communication between the financial institution computing system 104 and other systems, such as the mobile device 116. For example, the network interface 105 includes a cellular modem, a Bluetooth transceiver, a Bluetooth beacon, a radio-frequency identification (RFID) transceiver, and a near field communication (NFC) transmitter. In some arrangements, the network interface 105 includes the hardware and machine-readable media sufficient to support communication over multiple channels of data communication. Further, the network interface 105 may include cryptography capabilities to establish a secure or relatively secure communication session with the mobile device 116 or another device in communication with the financial institution computing system 104. In this regard, financial data (or other types of data) may be encrypted and transmitted to prevent or substantially prevent the threat of hacking.

The financial institution computing system 104 further includes a credentials database 130. The credentials database 130 may hold, store, categorize, and otherwise serve as a repository for the credentials of a user 120. As used herein, the term “credentials” includes one or more security elements a user 120 may be required to enter to gain access to the authentication system 102, where access is defined as any type of action that allows a user 120 to view, edit, and/or otherwise operate the authentication system 102 (e.g., complete financial transactions). As such, “credentials” may include, but are not limited to, a name, username, password, scanned eye data, facial data, fingerprint data, and so on of the user 120.

The credentials database 130 may also hold, store, categorize, and otherwise serve as a repository for predefined levels of authentication associated with different transaction levels. In this regard, the credentials database 130 may be communicably and operatively coupled to the authentication system 102 to provide access to such information, such that the authentication system 102 may determine if user credentials match what is stored in the credentials database 130. Accordingly, the credentials database 130 serves as a reference for the authentication system 102 to determine what types of transactions correspond to which levels of authentication. As used herein, the phrase “level of authentication,” also referred to herein as “authentication level,” refers to one or more predefined access levels that define the amount of authentication credentials needed by a particular user 120 and/or mobile device 116 to perform a given transaction based on whether the mobile device 116 is connected to a known or secure network 110. When referencing the levels of authentication (as well as the transaction levels), the levels ascend in regard to the required security clearance and/or authentication to perform that transaction. For example, the authentication needed for a first level transaction (referred to as a first level of authentication), is lower than the authentication needed for a second level transaction, and so on.

For a particular transaction request, the authentication system 102 utilizes the credentials database 130 to determine which levels of authentication to require of the user 120. In this regard, the term “credentials” additionally includes information regarding a unique identifier (e.g., MAC address, serial number, token, etc.) associated with the mobile device 116 of the user 120. For example, the credentials database 130 may store the unique identifier of a mobile device 116 that has previously connected to the network 110 and may additionally store to which accounts each mobile device 116 is bound. As used herein, the phrases “mobile device identifier” and “unique identifier” refer to any information associated with a mobile device that may be used to uniquely identify the mobile device. In this regard, the mobile device identifier may be any piece of information that is tied to, linked with, or associated with one mobile device (i.e., part of the unique “fingerprint” of the mobile device). Such information may be permanent or transient in nature, but is preferably at least semi-permanently associated with only one mobile device.

Credentials stored in the credentials database 130 provide access to information regarding an automatic first level of authentication of the mobile device 116 upon a connection to the network 110. As an example, once a mobile device 116 has successfully connected to the network 110, the credentials database 130 stores the unique identifier of the mobile device 116, the binding of the unique identifier to a user 120 and/or account of the user 120, and communicates that information to the authentication system 102 to authenticate the user 120 for a transaction.

The financial institution computing system 104 further includes an accounts database 128. The accounts database 128 may hold, store, categorize, and otherwise serve as a repository of account information for the customers of the financial institution (e.g., user 120 of the mobile device 116). The account information includes user account information (e.g., account numbers, account types), various statements (e.g., credit/debit statements for the accounts), transaction history (e.g., statements for funds transfer from or to the user 120), etc. When transactions occur via the transaction circuit 206, as described below, those transactions are reflected in the accounts database 128 and account statements are updated.

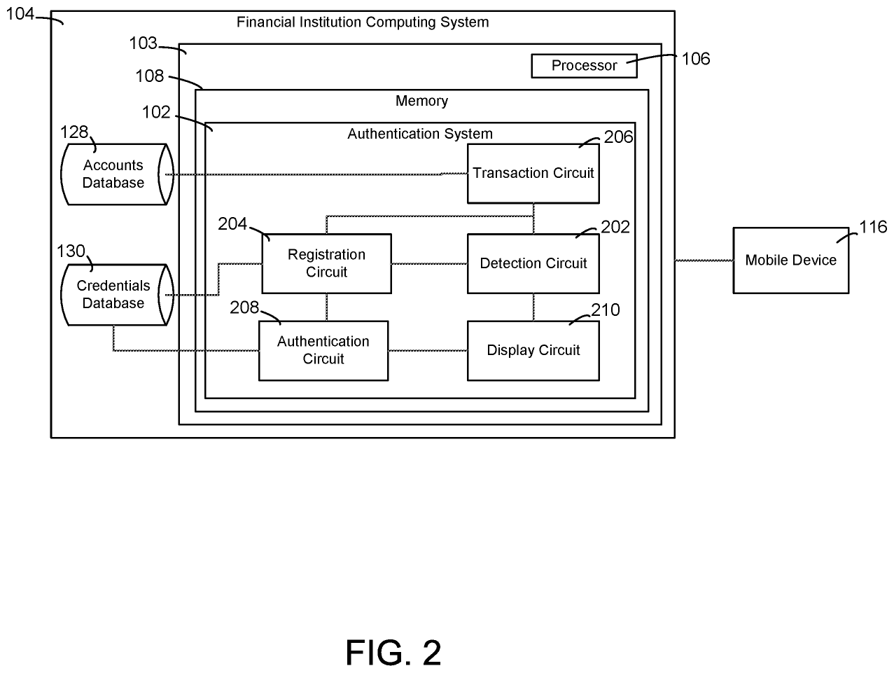

Referring now to FIG. 2, a diagram of an authentication system 102 and part of the financial institution computing system 104 of FIG. 1 are shown according to an example embodiment. The financial institution computing system 104 includes a processing circuit 103, which further includes a processor 106 and a memory 108. The processor 106 may be implemented as a general-purpose processor, an application specific integrated circuit (ASIC), one or more field programmable gate arrays (FPGAs), a digital signal processor (DSP), a group of processing components that may be distributed over various geographic locations or housed in a single location, or other suitable electronic processing components. The one or more memory devices 108 (e.g., RAM, NVRAM, ROM, Flash Memory, hard disk storage, etc.) may store data and/or computer code for facilitating the various processes described herein. Moreover, the one or more memory devices 108 may be or include tangible, non-transient volatile memory or non-volatile memory. Accordingly, the one or more memory devices 108 may include database components, object code components, script components, or any other type of information structure for supporting the various activities and information structures described herein.

In this example, the authentication system 102 may be embodied with the financial institution computing system 104. Accordingly, the authentication system 102 may be embodied or at least partly embodied in the memory 108, where at least some operations may be executable from the processing circuit 103. The authentication system 102 is shown to include a detection circuit 202, a registration circuit 204, a transaction circuit 206, an authentication circuit 208, and a display circuit 210, with all such circuits communicably and operatively coupled with to each another. Other embodiments may include more or less circuits without departing from the spirit and scope of the present disclosure.

The detection circuit 202 is structured to detect or receive an indication of the mobile device 116. In one embodiment, the detection circuit 202 includes machine-readable media operable to execute a detection program that facilitates the scanning of a predefined area for network-connected devices. For example, the machine-readable media may function like a search engine that acquires data indicative of one or more ports associated with a device to facilitate identification thereof (e.g., ports can include, but are not limited to, HTTP, SSH, FTP, and SNMP). In another embodiment, the detection circuit 202 may include or be communicably coupled to any type of sensor (e.g., a data tracking Bluetooth sensor) that facilitates, supports, or enables detection of the mobile device 116. For example, the sensor may include a Bluetooth sensor such that via Bluetooth pairing, the sensor may detect and identify Bluetooth enabled mobile device(s) 116. In still another embodiment, the detection circuit 202 may include any combination of a sensors and machine-readable media for facilitating detection and identification of one or more mobile devices 116.

The detection circuit 202 is further structured to identify the mobile device 116 upon connection to the network 110. The detection circuit 202 receives a mobile device identifier from the mobile device 116 upon connection to the network 110 to identify the device 116. In one embodiment, the mobile device identifier may include a MAC address of the mobile device 116. In another embodiment, the mobile device identifier may include a serial number of the mobile device 116. In other embodiments, the mobile device identifier may include any other information that may be used to uniquely identify the mobile device 116. The detection circuit 202 determines the identity of the mobile device 116 based on those unique identifiers.

In some embodiments, the financial institution computing system 104 is included on a financial institution device (e.g., an automated teller machine (ATM)), such that the financial institution computing system 104 directly detects or receives an indication of the mobile device 116, identifies the device 116 and to which accounts the device 116 is bound, and determines the identity of the user 120 associated with the mobile device 116. In this configuration, the financial institution device (e.g., an ATM) communicates directly with the mobile device 116. As an example, the financial institution device may selectively communicate with the mobile device 116 regarding requested transactions after receiving an indication of the location of that mobile device 116.

The registration circuit 204 is structured to register a mobile device 116 (e.g., bind the mobile device 116 to an account at the financial institution) upon the first instance of the mobile device 116 connecting to the network 110. The registration circuit 204 is communicably and operatively coupled to the detection circuit 202 and the credentials database 130 to receive information regarding whether the mobile device 116 has been registered previously. In this regard, completing registration of the mobile device 116 includes storing the unique identifier of the mobile device 116 in the credentials database 130 for reference at a later point in time. The registration of the mobile device 116 additionally includes binding (e.g., pairing) the mobile device 116 to an account of the user 120 and/or to the user 120 and storing the binding information in the credentials database 130 for reference when authenticating transactions using the mobile device 116. The registration circuit 204 is additionally communicably and operatively coupled to the input/output logic 135 of the mobile device 116 via the network 110 such that a user 120 may complete a registration process with the authentication system 102. For example, the user 120 is prompted by the registration circuit 204 to enter user credentials (e.g., username and password) to register the mobile device 116 with the network. In some embodiments, the mobile device 116 is automatically registered with the authentication system 102 by the registration circuit 204. In this regard, the registration circuit 204 receives a unique identifier from the mobile device 116 which is bound to an already authorized account held at the financial institution. For example, the user 120 may have opted in to automatic registration of the mobile device 116 upon connection to the network 110 such that no user login or authentication is needed for a first level transaction upon connecting to the network 110.

The transaction circuit 206 is configured to facilitate transactions involving the authentication system 102. The transaction circuit 206 receives a transaction request from the mobile device 116 over the network 110. In one embodiment, the transaction circuit 206 looks up the user 120 and other account information in the account database 128 and confirms whether the information is associated with an authorized user of a financial account. If known information matches the information in the transaction request, the transaction circuit 206 completes the transaction request. In another aspect, the transaction circuit 206 performs a series of checks before authorizing the transaction request. In some embodiments, this may be performed in connection with the authentication circuit 206. In this regard, the transaction circuit 206 is communicably and operatively coupled to the authentication circuit 208 to receive and send information regarding the transaction request. The transaction circuit 206 receives an indication from the authentication circuit 208 to not complete the transaction because the required authentication level was not met. Furthermore, the transaction circuit 206 receives an indication from the authentication circuit 208 that a second (or higher) level authentication was received and then proceeds to complete the transaction. In addition, the transaction circuit 206 determines whether the transaction request may be properly completed, for example, determining whether the financial account specified in the transaction request contains sufficient funds to cover a transfer of funds. In one embodiment, if the transaction request is properly authenticated and the underlying transaction may properly be completed, the transaction circuit 206 authorizes and completes the transaction request. The transaction circuit 206 additionally relays the information relating to the transaction to the display circuit 210 to facilitate displaying the transaction and/or transaction confirmation or denial on the mobile device 116.

The authentication circuit 208 is structured to facilitate authentication of a transaction. In this regard, the authentication circuit 208 determines that the mobile device 116 and/or user 120 is registered with the authentication system 102 upon connection of the device 116 to the network 110, receives the transaction request from the transaction circuit 206, and determines a level of authentication needed for a transaction request from the mobile device 116. Accordingly, the authentication circuit 208 is communicably and operatively coupled to the transaction circuit 206 and the credentials database 130. If the authentication circuit 208 receives a transaction request from the transaction circuit 206 and determines that a transaction request is of a first level, the authentication circuit 208 checks the credentials database 130 to determine that the mobile device has previously been registered on the secure network 110 and bound to an account, and generates and transmits a message to the transaction circuit 206 to complete the transaction. The authentication circuit 208 may additionally generate a message for display on the mobile device 116 via the display circuit 210 indicating the transaction was completed. If the authentication circuit 208 receives the transaction request from the transaction circuit 206 and determines that the request is of a higher level (e.g., second level transaction), the authentication circuit 208 communicates with the transaction circuit 206 that further authentication is necessary and communicates with the display circuit 210 to display a generated higher level authentication prompt based on the transaction request received from the transaction circuit 206.

In one embodiment, the authentication circuit 208 is communicably coupled to the input/output logic 135 of the mobile device 116 and to the credentials database 130, such that the authentication circuit 208 may authenticate a user 120 through user input, such as a user login and password. By communicating with the credentials database 130, the authentication circuit 208 uses the identification to determine the level of authentication of the mobile device 116 by receiving information from the credentials database 130 regarding a stored unique identifier matching that of the mobile device 116 and information regarding the binding of the unique identifier to an account of the user 120 at the financial institution. As mentioned above, the credentials database 130 may store and provide access to credentials of the user 120, including, but not limited to name, username, password, mobile device identifiers, scanned eye data, facial data, fingerprint data, and so on of the user 120. As an example, the user login may include a username, in the form of a self-designated username, an account number, or any other identifiable combination of letters, numbers, and symbols. The user login may additionally include a password, or other passcode, that the user 120 inputs to the mobile device 116. When the mobile device 116 has been registered, the authentication circuit 208 may be configured to request additional authentication information (e.g., due to a second level transaction) from the user (e.g., a username/password, PIN, answers to one or more security questions, etc.). The authentication circuit 208 prompts (e.g., via the display circuit 210) the user 120 to input the additional authentication information once the user 120 has requested a transaction requiring a higher level of authentication. For example, the prompt facilitates the reception of the user credentials for a second level of authentication associated with a transfer of greater than $1000.

In another embodiment, the authentication circuit 208 is communicably coupled to a mobile device 116 that includes a fingerprint sensor for receiving a fingerprint and/or handprint of the user 120. For example, in some arrangements, the mobile device 116 includes a fingerprint sensor such that when the user 120 picks up the device 116 and/or places a finger on a sensor on the device 116, the sensor transmits the fingerprint to the authentication circuit 208 and the authentication circuit 208 then authenticates the user 120 based on that fingerprint. In still another embodiment, the authentication circuit 208 is communicably coupled to a mobile device 116 that includes an eye scanner (e.g., retinal scanner, iris scanner) for receiving a scan of the eye of the user 120. For example, the eye scanner scans an eye of the user 120 and compares the scanned data to data stored in the credentials database 130 to determine the identity of the user 120. In yet another embodiment, the authentication circuit 208 is communicably coupled to a mobile device 116 that includes facial recognition circuitry, wherein the facial recognition circuitry determines the identity of the user 120 by collecting facial data points, for example, by using a camera on the mobile device 116 and comparing them to known facial data points in the credentials database 130. In other embodiments, the authentication circuit 208 includes or is communicably coupled to any combination of user input, sensor, scanner, or facial recognition circuitry to determine the identity and a level of authorization of the user 120. Based on the user credential received from the mobile device (e.g., eye scan, facial recognition, fingerprint sensor, etc.), the authentication circuit 208 determines an identity of the user 120 to authenticate the transaction. It should be understood that the aforementioned list is not meant to be limiting as other credentials may be used by the authentication circuit 208 to authenticate the user 120 of the mobile device 116.

The authentication system 102 further includes a display circuit 210. The display circuit 210 is structured to generate and provide a message to the mobile device 116 to display information regarding a transaction request (or transaction confirmation) and to also display a higher level of authentication prompt (e.g., pop-up window as shown in FIG. 6), based on the transaction request received from the mobile device 116. Accordingly, the display circuit 210 includes communication circuitry for facilitating the exchange of information between and among the display circuit 210 and any other circuitry or logic. In this regard, the display circuit 210 is communicably and operatively coupled to the detection circuit 202, transaction circuit 206, authentication circuit 208, and the input/output logic 135 of the mobile device 116.

As an example, the display circuit 210 receives information that a second level of authentication is needed from a user 120 prior to completing the requested transaction. The display circuit 210 may receive the authentication information from the authentication circuit 208. The display circuit 210 generates a second level authentication prompt based on the transaction request to be displayed on the mobile device 116, as discussed further herein with regard to FIG. 6. The second level authentication prompt may be a username and password prompt to the user 120. Once the user 120 inputs the username and password and the transaction is authenticated to a second level and completed, the display circuit 210 generates a confirmation for display on the mobile device 116.

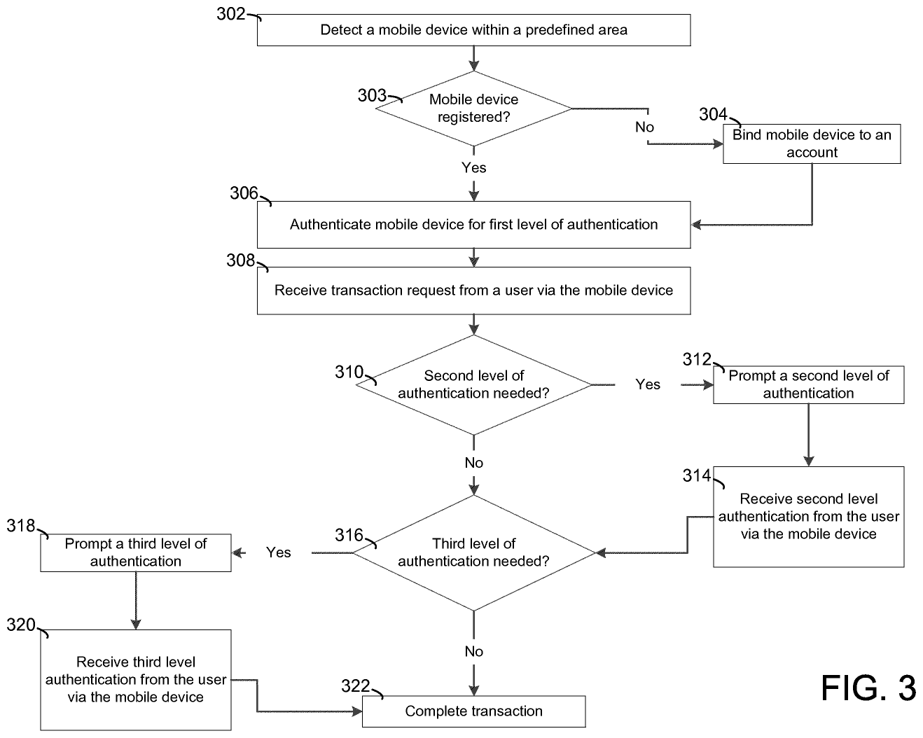

Referring now to FIG. 3, a flow diagram of a method 300 of authenticating a mobile device connected to a secure network is depicted according to an example embodiment. Method 300 may be implemented by the authentication system 102 of the financial institution computing system 104 (e.g., as shown in FIGS. 1-2), such that reference may be made to one or more components of FIGS. 1-2 in explaining method 300.

A mobile device is detected within a predefined area at 302. The mobile device is detected by the detection circuit 202. The predefined area may include any area where a secure network 110 is set up and affiliated with the financial institution. As mentioned above, detecting the mobile device 116 may be performed using any suitable component and process. In one embodiment, the detection circuit 102 may include machine-readable media operable to execute a detection program that facilitates the scanning of a predefined area for network-connected devices. In another embodiment, the mobile device 116 may be detected using any type of sensor (e.g., a data tracking Bluetooth sensor). For example, there may be a detecting sensor located with the financial institution computing system 104 embodied on a financial institution device, such as an ATM. The detection circuit 202 may detect and identify a mobile device 116 via a mobile device identifier associated with the device 116 connected to the network 110.

Registration of a mobile device is determined at 303. The registration circuit 204 determines whether the mobile device is registered with the system 100. The registration circuit 204 communicates with the credentials database 130 to determine that a mobile device 116 has or has not been registered with the network 110 previously. Upon connection to the network 110 and identification of the mobile device 116 by the detection circuit 202 as described above, the unique identifier of the mobile device 116 is stored in the credentials database 130 to be accessed by the system 100 (e.g., by the authentication circuit 208 authenticating a transaction request). Storing the unique identifier of the mobile device 116 and binding the unique identifier to an account at the financial institution allows for a determination that the mobile device 116 has already been registered with the secure network 110.

The mobile device is bound to an account at 304. The mobile device 116 is bound to an account by the registration circuit 204. The registration circuit 204 may automatically bind the mobile device 116 upon connection to the network 110 and upon determination that the mobile device 116 is not already registered with the network 110. To complete the binding process, the registration circuit 204 may receive user credentials (e.g., username and password) from the mobile device 116. In some embodiments, the mobile device 116 is automatically registered with the network 110 by the registration circuit 204, including binding of the mobile device identifier to an account at the financial institution. In this regard, the registration circuit 204 receives the unique identifier from the mobile device 116 upon connection to the network 110 such that the device 116 is determined to be bound to an already authorized account held at the financial institution. As mentioned above, the registration process may be automatic if a user 120 had previously opted in or agreed to automatic binding of the mobile device 116.

The mobile device 116 is authenticated at 306. In some arrangements, the mobile device 116 is authenticated by the authentication circuit 208. The authentication circuit 208 automatically authenticates a transaction request from the mobile device 116 if that device is already bound to an account at the financial institution (i.e., the mobile device 116 has been bound to an account at process 304). The automatic authentication may only be for certain transactions deemed by the authentication circuit 208 (and stored by the credentials database 130) to be a type of transaction requiring only a first level of authentication (e.g., a first level transaction). For example, a first level transaction may be a transaction of transferring less than $1000.

A transaction request is received at 308. The transaction circuit 206 receives transaction requests from the user 120 via the mobile device 116. Transaction requests include a request to transfer funds to another account holder at the financial institution or to an account holder at a different financial institution, as well as many other types of transactions.

A second level of authentication is determined to be required for the transaction at 310. In some arrangements, the authentication circuit 208 and the credentials database 130 determine that the second level of authentication is needed. As described above, the authentication circuit 208 determines what level of authentication is needed for a particular transaction based on a predetermined transaction level associated with the transaction type. In this regard, the authentication circuit 208 communicates with the transaction circuit 206 to receive the transaction request type and determine the level of authentication required to complete the request. If a second authentication level is needed, the authentication circuit 208 then prompts the user 120 via the display circuit 310 to enter further user credentials (process 312). For example, a second authentication level may be necessary for a second level transaction (e.g., transferring more than $1000 to another user, etc.).

A second level of authentication is prompted at 312. The second level of authentication is prompted by the authentication circuit 208 and display circuit 210. When a second level of authentication is necessary, the authentication circuit 208 communicates to the display circuit 210 that a second level of authentication is required and the display circuit 210 generates and provides a message to the mobile device 116 to prompt the user 120 to enter further user credentials. User credentials include, but are not limited to, a name, username, password, scanned eye data, facial data, fingerprint data, and so on of the user 120. For example, the user requests to transfer $2000 to another user. Once the user enters that information into the mobile device 116, the transaction circuit 206 communicates with the authentication circuit 208, which determines that a second level of authentication is needed to complete the transaction. The authentication circuit 208 also determines that the mobile device 116 is registered using information stored in the credentials database 130. The authentication circuit 208 and display circuit 210 then generate and transmit a prompt to the user 120 via the mobile device 116 to enter a username and password to complete the transaction.

A second level of authentication is received at 314. In some arrangements, the authentication circuit 208 receives the second level of authentication. As mentioned above, the authentication circuit 208 receives user input (e.g., user login) corresponding to a set of credentials in the credentials database 130. The authentication circuit 208 uses the user input to determine the identity of the user 120. In another embodiment, the authentication circuit 208 may determine the identity of the user 120 by various other techniques, such as sensing a fingerprint of the user 120, scanning an eye of the user 120, and using facial recognition systems. These techniques may be performed as a registration process or a higher level authentication process for a user 120 using the mobile device 116. Once the user 120 enters the required credentials, the authentication system 102 repeats processes 310-314 (shown as third level authentication processes 316, 318 and 320) to determine whether even higher levels of authentication are necessary. The third level authentication process may include any combination of the above mentioned user inputs to further authenticate the user 120.

When all required authentication is received from the user 120, the transaction is then completed at 322. Process 322 is performed by the transaction circuit 206. The transaction circuit 206 communicates with the authentication circuit 208 to determine that the transaction is properly authenticated and also communicates with the accounts database 128 to determine whether the transaction can occur based on information such as account balances, account types, etc. The transaction circuit 206 additionally stores the completed transaction information in the accounts database 128 and updates any balances or logs in the accounts database 128 to reflect the transaction.

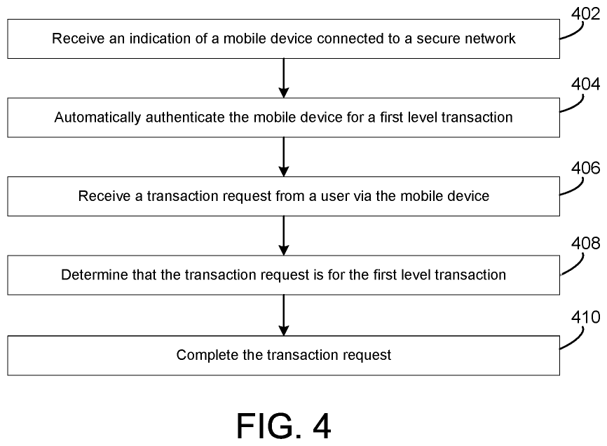

Referring now to FIG. 4, a simplified process of automatically authenticating a transaction based on a mobile device being connected to a secure network is shown, according to an example embodiment. An indication of a location of a mobile device connected to a secure network is received at 402. The detection circuit 202 receives a unique identifier (e.g., MAC address, serial number, token, etc.) from the mobile device 116 upon connection to the network 110 to identify the device 116. The unique identifier associated with the mobile device 116 is received by the detection circuit 202 and stored in the credentials database 130. The mobile device identifier is bound to an account at the financial institution such that each time the mobile device 116 is connected to the secure network 110 after initial registration and binding of the device 116 to an account, the bound device 116 can be automatically authenticated for a first level transaction associated with that account.

The mobile device is automatically authenticated for a first level transaction at 404. Process 404 is performed by the authentication circuit 208. The authentication circuit 208 is structured to automatically authenticate the mobile device 116 for a first level transaction if the mobile device 116 has previously connected to the network 110 and has been bound to an account. The automatic authentication may only be for certain transactions deemed by the authentication circuit 208 (and stored by the credentials database 130) to be a type of transaction requiring only a first level of authentication (e.g., a first level transaction). For example, a mobile device 116 may be automatically authenticated for a transaction of transferring less than $1000.

A transaction request from a user via the mobile device is received at 406. The transaction circuit 206 receives the transaction request from the mobile device 116. The user 120 inputs the transaction request into the mobile device 116 while connected to the network 110 allowing for the authentication system 102 to receive the transaction request via the transaction circuit 206.

The transaction request is determined to be for a first level transaction at 408. In some arrangements, the transaction circuit 206 and authentication circuit 208 determine that the transaction request is for a first level transaction. The transaction circuit 206 communicates with the authentication circuit 208 and credentials database 130 to determine that the transaction request is for a first level transaction. For example, the transaction request is for a transfer of $500 to another customer of the financial institution and the credentials database 130 stores information that indicates a first level transaction is any transfer of less than $1000. Thus, the transaction circuit 206 can then communicate to the authentication circuit 208 that the transaction request qualifies as a first level transaction (e.g., a transaction eligible for automatic authentication if the user 120 has successfully registered and bound the mobile device 116 to an account at the financial institution during a previous connected session to the network 110).

The transaction is completed at 410. The transaction circuit 206 completes the transaction request. Upon determination that the transaction request is for a first level transaction, the transaction circuit 206 checks with the accounts database 128 to determine that the transaction can successfully take place based on information such as account balances, account types, etc. Once the transaction circuit 206 verifies that the transaction will be successful, the transaction circuit 206 proceeds with completion of the transaction. In the above example, the $500 is then transferred to the other customer of the financial institution.

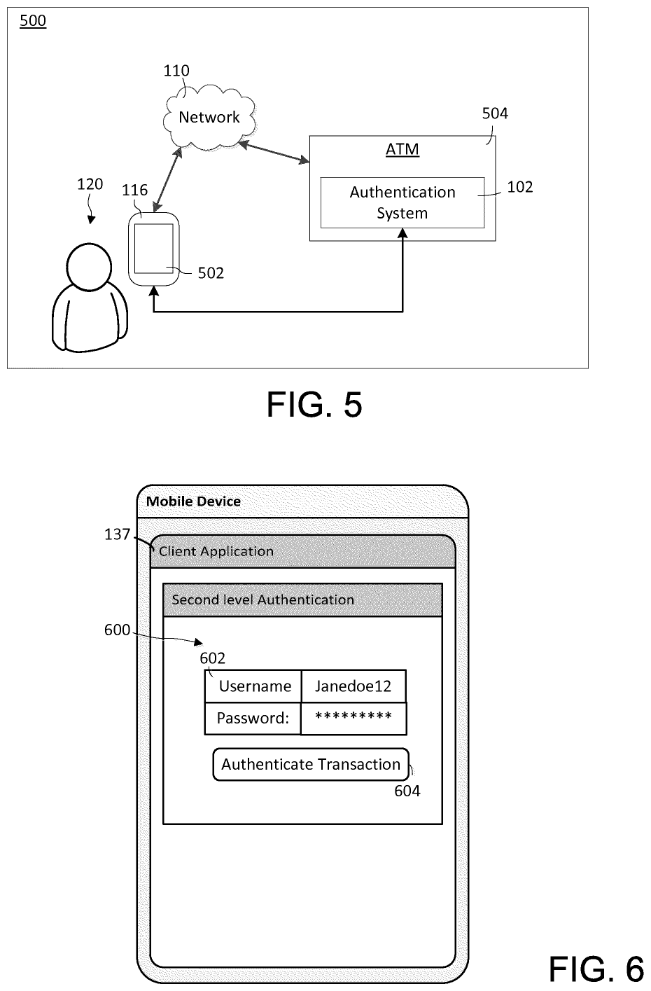

With the aforementioned description in mind and with reference to FIGS. 5-6, an example implementation of process 400 may be described as follows. As shown in FIG. 5, a user 120 is positioned within an environment, shown as a financial institution 500. In this example, the mobile device 116 includes an input/output device 502 (e.g., touch screen, microphone, speaker, keyboard, etc.) to accept user input and the mobile device 116 is in communication with the authentication system 102 to perform the following functions. Accordingly, using the network capabilities of the mobile device 116 (e.g., Wi-Fi, Bluetooth, Internet), the mobile device 116 communicates with the other networked devices (e.g., ATM 504). As shown in this example, the ATM 504 functions as the financial institution computing system 104 and includes the authentication system 102. Therefore, the ATM is structured to detect and identify one or more mobile devices 116 (process 402) upon connection to the network using the unique identifier of the devices 116. When the mobile device 116 connects to the network 110, the ATM 504 automatically authenticates the mobile device 116 for a first level transaction (e.g., transfer of $1000 or less). Once the user 120 inputs a transaction request into the input/output device 502 of the mobile device 116, the ATM 504 receives that request (process 406) and determines that the request is for a first level transaction (process 408). The ATM 504 proceeds to complete the transaction (process 410). In this example, the user 120 does not need to enter any additional information to complete or authenticate the transaction.

Referring now to FIG. 6 with reference to FIGS. 3 and 5, a pop-up window of the second level authentication prompt is shown on the mobile device 116, according to an example embodiment. In this example, the second level authentication window 600 prompts the user 120 to enter a username and password to gain access to a second level transaction request. If the user 120 enters credentials 602 (e.g., username and password) and selects the authenticate transaction selection 604, the authentication system 102 allows completion of a second level transaction. These functions may be performed on a mobile device 116 using a client application 137. The client application 137 displays the second level authentication window such that the user 120 may interact with the application 137 and transmit user credentials to the authentication system 102. In other embodiments, the second level authentication may use other credentials to authenticate the user for a second level (or higher) transaction. As described above, this process may be used for levels of authentication beyond a second level as necessary. As such, further pop-up windows may be displayed or different screens may be displayed in place of the second level authentication window 600 shown in FIG. 6.

Based on the foregoing, an example process may be described as follows. In a financial institution environment, a secure network is setup. In other examples, the financial institution may set up a secure network at a different location, such as a coffee shop, gas station, department store, home of the user, and so on. For illustration purposes, an ATM that includes the authentication system is located in the financial institution environment. The ATM may be monitoring the network for new mobile devices on an on-going basis. Once detected by the authentication system, the mobile device is authenticated for certain transactions (e.g., a first level transaction). The ATM may further authenticate the user and/or mobile device for other transactions based on entry of credentials from the user for each level of authentication required. For example, if the user desires to transfer a very large amount of money (or pay for a large purchase), the level of authentication required for that transaction may be a third level of authentication. The user may then be required to enter two rounds of authentication beyond merely connecting to the secure network to proceed with the transaction. In this example, once the user has been authenticated to a third level, the transaction is processed by the authentication system.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A system comprising:
a processor coupled to a non-transitory storage medium, wherein the processor is structured to:
receive an indication of a mobile device connected to a secure network provided by a financial institution;
automatically associate the mobile device with a user account at the financial institution responsive to the indication;
identify the mobile device based on a unique identifier of the mobile device;
automatically authenticate the mobile device for a first level transaction based on the indication of the mobile device being connected to the secure network;
receive a transaction request from a user via the mobile device;
determine that the transaction request is for the first level transaction; and
complete the transaction request.

2. The system of claim 1, wherein the processor is further structured to:
determine that the mobile device is not registered with the secure network;
generate and transmit a message to the mobile device to display a user input prompt;
receive credentials of the user of the mobile device;
determine an identity of the user of the mobile device based at least in part on the credentials of the user; and
register the mobile device as a recognized device, wherein registering the mobile device includes storing the credentials of the user in a credentials database.

3. The system of claim 1, wherein the secure network is located proximate an automated teller machine (ATM) provided by the financial institution.

4. The system of claim 1, wherein the secure network is provided by the financial institution at a partnered location, wherein the partnered location includes at least one of a gas station, a department store, a grocery store, and a coffee shop.

5. The system of claim 1, wherein the secure network is located at a residence of the user.

6. The system of claim 1, wherein the credentials of the user include a user login and password.

7. The system of claim 2, wherein the mobile device is automatically registered upon connection to the secure network.

8. The system of claim 1, wherein the transaction request includes at least one of a funds transfer request, bill payment, and mortgage payment.

9. The system of claim 1, wherein the processor is further structured to:
generate and transmit a hyperlink to be displayed on the mobile device, wherein the hyperlink, when selected, registers the mobile device and authenticates the first level transaction.

10. A system comprising:
a processor coupled to a non-transitory storage medium, wherein the processor is structured to:
receive an indication of a mobile device connected to a secure network provided by a financial institution;
automatically associate the mobile device with a user account at the financial institution;
identify the mobile device based on a unique identifier of the mobile device;
authenticate the mobile device for a first level transaction based on the indication of the mobile device being connected to the secure network;
receive a transaction request from a user via the mobile device;
determine a level of authentication necessary to complete the transaction request;
prompt a second level of authentication, based at least in part on the level of authentication necessary to complete the transaction request;
receive the second level of authentication from the user via the mobile device; and
complete the transaction request.

11. The system of claim 10, wherein the second level of authentication includes credentials of the user, wherein the credentials include a user login and password.

12. The system of claim 10, wherein the second level of authentication includes credentials of the user, wherein the credentials include at least one of a fingerprint, eye scan, and facial recognition of the user, wherein the credentials are received via the mobile device.

13. The system of claim 10, wherein a prompt for the second level of authentication is displayed on the mobile device as a pop-up window.

14. The system of claim 10, wherein the processor is further structured to:
prompt a third level of authentication, based at least in part on the level of authentication necessary to complete the transaction request; and
receive the third level of authentication from the user via the mobile device.

15. The system of claim 10, wherein the transaction request includes at least one of a funds transfer request, bill payment, and mortgage payment.

16. The system of claim 10, wherein the first level transaction includes a transfer of a first amount of money and the second level transaction includes the transfer of a second amount of money;
wherein the second amount of money is greater than the first amount of money.

17. The system of claim 10, wherein the processor is further configured to:
generate and transmit a hyperlink to be displayed on the mobile device, wherein the hyperlink, when selected, registers the mobile device with the secure network, binds the mobile device to an account at the financial institution, and automatically authenticates the first level transaction.

18. A method comprising:
receiving, by a financial institution computing system comprising at least one processor connected with at least one memory device, an indication of a mobile device connected to a secure network provided by a financial institution;
identifying, by the financial institution computing system, a unique identifier associated with the mobile device;
automatically binding, by the financial institution computing system, the mobile device via the unique identifier to a user account at the financial institution;
automatically authenticating, by the financial institution computing system, the mobile device for a first level transaction upon detection of connection to the secure network by the mobile device;
receiving, by the financial institution computing system, a transaction request from the user via the mobile device;
determining, by the financial institution computing system, that the transaction request is for the first level transaction; and
completing, by the financial institution computing system, the first level transaction.

19. The method of claim 18, further comprising:
determining, by the financial institution computing system, that the mobile device is not registered;
receiving, by the financial institution computing system, credentials of the user of the mobile device;
determining, by the financial institution computing system, an identity of the user of the mobile device based at least in part on the credentials of the user; and
registering, by the financial institution computing system, the mobile device as a recognized device, wherein registering the mobile device includes storing the credentials of the user in a credentials database.

20. The method of claim 18, further comprising:
receiving, by the financial institution computing system, a second transaction request from the user via the mobile device;
determining, by the financial institution computing system, that the second transaction request is for a second level transaction;
prompting, by the financial institution computing system, a second level of authentication based at least in part on the level of authentication necessary to complete the second transaction request;
receiving, by the financial institution computing system, the second level of authentication from the user via the mobile device; and
completing, by the financial institution computing system, the transaction request.
